(19) United States
(12) Patent Application Publication
(10) Pub. No.: US 2006/0222368 A1
(43) Pub. Date: Oct. 5, 2006

(54) MULTI-ANGLE REMOTE CONTROL

(76) Inventor: Carlos Osuna, Santa Barbara, CA (US)

Correspondence Address: LAURA N. TUNNELL, P.O. BOX 91929, SANTA BARBARA, CA, 93190, US

(21) Appl. No.: 11/160,507

(22) Filed: Jun. 27, 2005

Related U.S. Application Data
(60) Provisional application No. 60/594,325, filed on Mar. 29, 2005.

(51) Int. Cl. H04L 17/02

(52) U.S. Cl. 398/106; 341/176; 340/825.72

(57) ABSTRACT

A multi-angle remote control device is disclosed. Two or more emitters are strategically placed such that an effective composite angular emission range of at least 180 degrees is achieved. This device is particularly well-suited for use within enclosures that are not amenable to reflecting signals from walls and other room structures.

### BACKGROUND

During the past decade, remote control devices have become an integral part of everyday life. Audio-visual components, lights, window shades, and ceiling fans, to name a few, are conveniently controllable using some type of remote device. Such instruments have only one emitter, wherein the one emitter has an effective angular range of about 90 degrees. For these devices to function, either direct pointing between the emitter and receiver is required, or the emission signal is transmitted to the receiver by reflections from walls and other room structures.

Much of the time, an effective transmit-receive link is achieved with single emitter devices. However, many types of paints commonly used for interior structures interfere with transmission signals. Consequently, they do not effectively function to augment a transmitted beam by reflection. Oil paint, varnish enamel, latex, water-reducible, alkyds, several types of epoxy, urethane-modified alkyds, acrylic-urethane coatings, aluminum, shellac, lead, linseed oil, and marine finishes are common paints that fit this description.

In addition to paints and other stealth surface coverings, solid shapes and voids such as alcoves, doorways, and corners have anechoic properties as well. Bookshelves and other irregular structures prevent efficient beam reflection. In short, any system that is dependent upon the ambient reflective properties of its immediate environment is open to failure unless one resorts to the “direct pointing” method of attaining the necessary transmit-receive link.

“Direct pointing” presents the user with a situation that may be physically uncomfortable, requiring undue tension in the wrist, forearm and finger muscles. Such tension can aggravate or even cause carpal tunnel syndrome. The need for direct pointing often dictates an uncomfortable body angle or position. Consequently, there remains a need for a remote control device that functions as a stand-alone, wide angle emitter.

### SUMMARY

A remote control device is disclosed. The device comprises a housing, a circuit board within the housing and two or more LED's (Light Emitting Diodes) disposed on the circuit board. A power source and driver circuit operable for supplying current to the LED's are disposed within the housing as well.

Each LED emits a beam that can be characterized by an emission angle. A composite emission angle greater than the emission angle of a single LED can be effected by judicious placement of two or more LED's on the circuit board. A three LED arrangement is described wherein a composite emission angle of at least 270 degrees is achieved.

It is an objective of the present invention to provide a stand-alone wide angle remote control device for use with audio-visual, lights, fans, and other common electrical components.

It is an objective of the present invention to provide a stand-alone wide angle remote control device that does not require direct line-of-sight pointing.

It is an objective of the present invention to provide a wide angle remote control device that functions independently of reflections from external room structures.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### DESCRIPTION OF THE PREFERRED EMBODIMENTS

The definitions below serve to provide a clear and consistent understanding of the specification and claims, including the scope given to such terms.

Anechoic—neither having nor producing echoes within a limited range of wavelengths

LED—Light Emitting Diode

PCB—Printed Circuit Board

IC—Integrated Circuit

### BRIEF DESCRIPTION OF THE DRAWINGS

FIG. 1 illustrates the general emission properties of a prior art remote control unit.

FIG. 2 illustrates the general emission properties of the remote control unit of the present invention.

FIG. 3 indicates a circuit diagram operable for driving for the remote control unit of the present invention.

FIG. 4 illustrates the LED arrangement on the PCB.

### IDENTIFICATION OF NUMBERS USED IN THE DRAWINGS

100—prior art remote control unit

110—LED and associated emission range

200—remote control unit of the present invention

300—Potential circuit diagram for multi-angle remote control unit

310—resistor

320—LED

330—voltage source

340—transistor

350—ground

360—remote control integrated circuit

370—oscillator

380—capacitor

400—PCB

410—LED

### DETAILED DESCRIPTION OF THE PREFERRED EMBODIMENTS

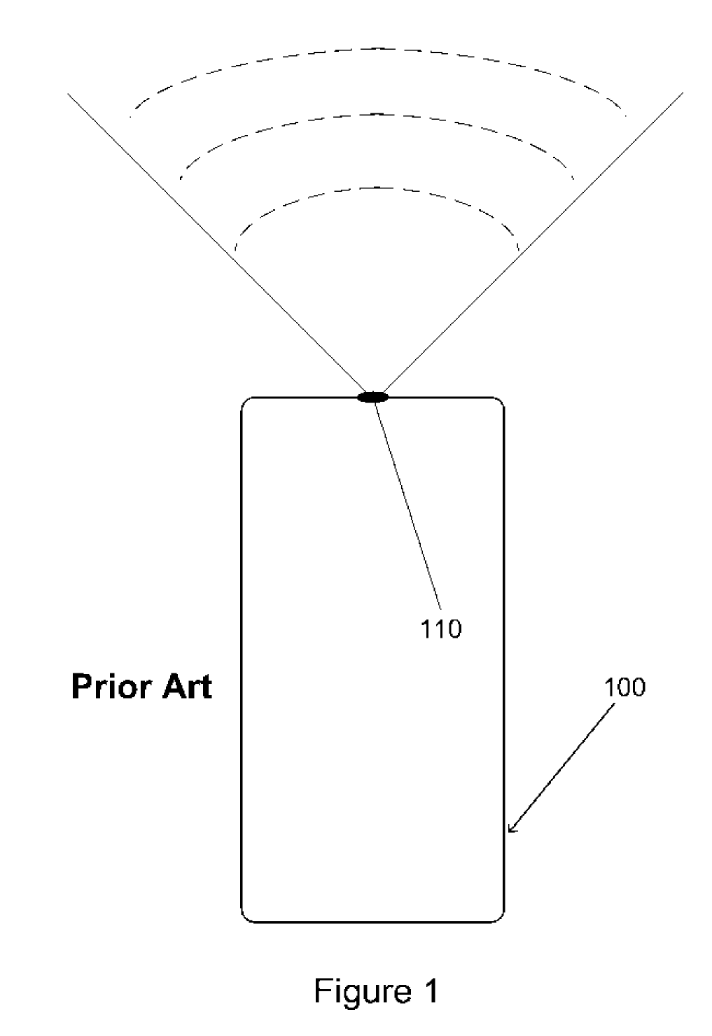

A prior art remote control device is indicated in FIG. 1. It has a single LED (110) and associated circuitry enclosed by a housing (100). A single LED, such as the LED indicated at (110), has a typical emission angle of 90-100 degrees.

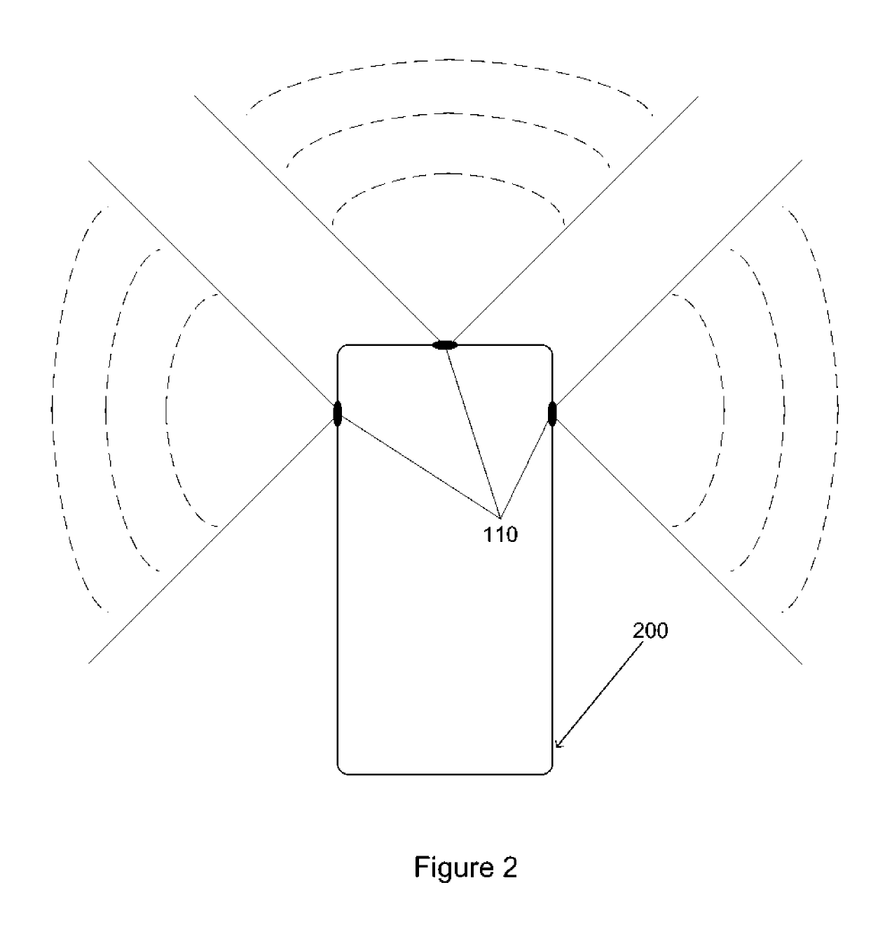

A remote control device in accordance with the present invention is shown in FIG. 2. In this example are three LED's (110), having a combined emission angle of about 270 degrees. Such an enhanced emission angle reduces or eliminates the device's dependence on the reflective properties of its environment. Elimination of the need for direct pointing allows the wrist, forearm and finger muscles to relax. It permits relief from pain due to carpal tunnel syndrome and enables the user to operate the device from any body angle and body position.

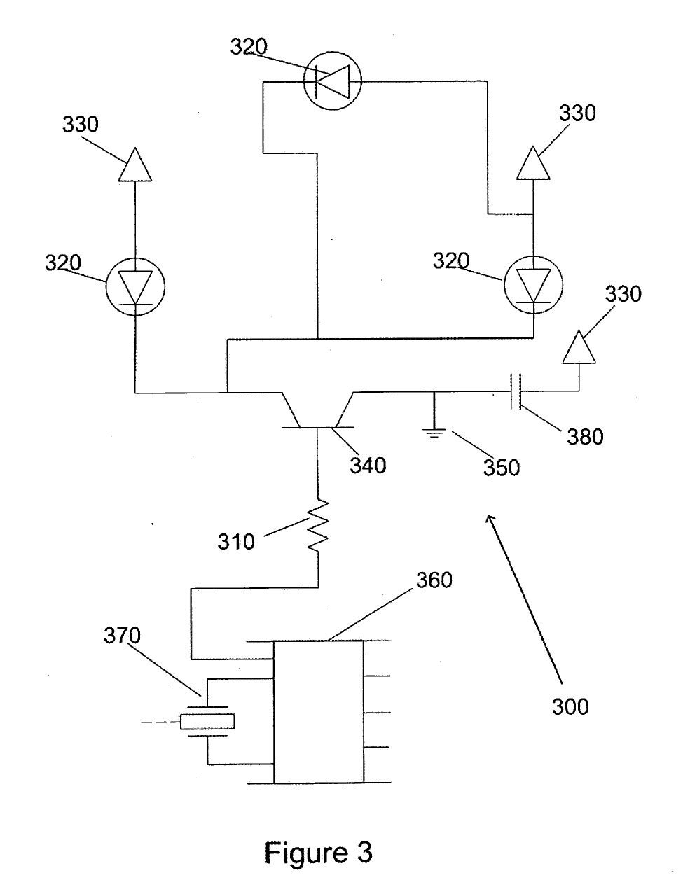

FIG. 3 illustrates a basic wiring diagram (300) for a 3-LED remote control device. The sequence of operation is as follows:
(1) User inputs information via the remote control keypad (not shown).
(2) The information is transmitted to the remote control integrated circuit (360).
(3) The integrated circuit (360) generates a signal and transmits the signal to the transistor (340).
(4) The transistor (340) amplifies the signal and subsequently routes it to multiple (in this case, three) LED's (320) configured in parallel.
(5) The LED's (320) transmit the signal in multiple directions.

In addition, the oscillator (370) provides the circuits' clock. Current flow is limited by a resistor (310) placed between the integrated circuit (360) and transistor (340). Noise and spikes are filtered out of the signal via a capacitor (380).

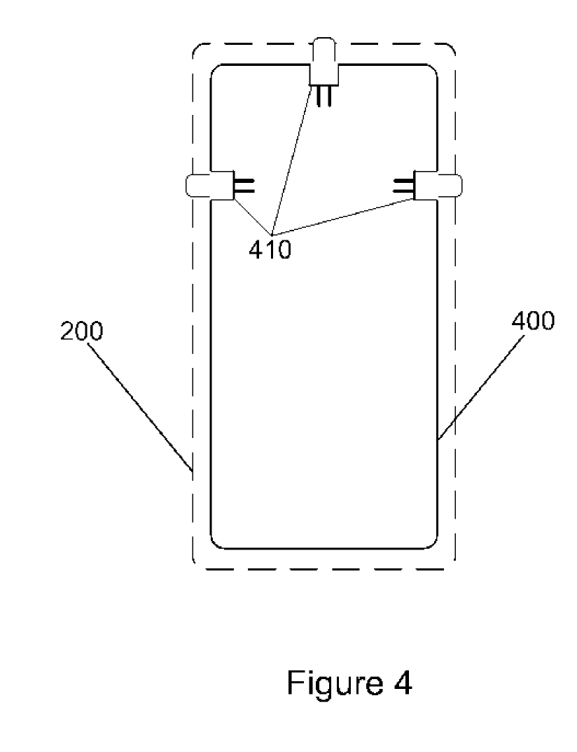

FIG. 4 illustrates a three LED arrangement (410) on a PCB (400). The housing is indicated in phantom. The configuration of FIG. 4 results in the combined transmission angle indicated in FIG. 2. Although a three LED geometry is used in these examples, the general idea can be extended to any arrangement of two or more LED's.

What is claimed is:

1. A remote control apparatus comprising:
a. A housing,
b. Two or more light emitting diodes disposed within said housing, wherein each of said light emitting diodes emits a beam, wherein said beam is characterized by an emission angle, and wherein a composite emission angle is effected by judicious placement of said two or more light emitting diodes within said housing,
c. A circuit board disposed within said housing and operable for mounting said diodes, wherein said diodes are arranged on said circuit board such that said composite emission angle is greater than 180 degrees,
d. A driver circuit operable for supplying current to said diodes and,
e. A power source.

2. A remote control apparatus as in claim 1 wherein three of said light emitting diodes are mounted on said circuit board, and wherein said three light emitting diodes are arranged so that said composite emission angle is at least 270 degrees.
